(19) United States
(12) Patent Application Publication
(10) Pub. No.: US 2026/0312507 A1
(43) Pub. Date: Oct. 8, 2026

(54) CIRCUIT FOR DRIVING A MOTOR OF A VACUUM PUMP, VACUUM PUMP ASSEMBLY, AND METHOD

(71) Applicant: Edwards Limited, Burgess Hill, Sussex (GB)

(72) Inventors: James Alexander Haylock, Burgess Hill, Sussex (GB); Jian Li, Burgess Hill, Sussex (GB)

(21) Appl. No.: 19/484,703

(22) PCT Filed: May 7, 2024
(86) PCT No.: PCT/GB2024/051188

§ 371 Date: Nov. 14, 2025

(30) Foreign Application Priority Data
May 16, 2023 (GB) 2307257.2

(51) Int. Cl. H02M 5/458; H02M 1/12

(52) U.S. Cl. CPC H02M 5/4585; H02M 1/12

(57) ABSTRACT

A circuit for driving a motor of a vacuum pump. The circuit comprises a filter configured to receive an alternating current ‘AC’ electrical input power. The filter is configured to supply, a filtered AC electrical power. The circuit comprises an active-front-end ‘AFE’ rectifier configured to receive the filtered AC electrical power. The AFE rectifier comprises a plurality of electrically connected switching devices. The plurality of switching devices are controllable, by a plurality of switching signals, to convert the filtered AC electrical power to a direct current ‘DC’ electrical power. The circuit comprises an inverter configured to receive the DC electrical power. The inverter is configured to convert the DC electrical power to an AC electrical output power for driving a motor of a vacuum pump.

### CROSS-REFERENCE TO RELATED APPLICATION

This Application is a Section 371 National Stage Application of International Application No. PCT/GB 2024/051188, filed May 7, 2024, and published as WO 2024/236271 A1 on Nov. 21, 2024, the contents of which is hereby incorporated by reference in its entirety and which claims priority of British Application No. 2307257.2, filed May 16, 2023.

### FIELD

The field of the invention relates to vacuum pumps, and more specifically to circuits for driving motors of vacuum pumps.

### BACKGROUND

Conventionally, vacuum pumps are driven by motors. The motors typically receive electrical power from an alternating current (AC) grid power supply. A drive circuit for a motor of a vacuum pump will typically rectify this AC electrical power in order to generate direct current (DC) power that can be smoothed, stored, and then inverted to provide AC output power with the necessary frequency and voltage for driving the motor of the vacuum pump.

Currently, the rectification process is performed by three-phase diode rectifiers. The naturally rectified DC voltage produced by the diode rectifier will be equal to, or just below, the line-to-line AC supply voltage i.e. the square-root of 2, multiplied by the line-to-line root mean square (RMS) AC supply voltage for a sinusoidal supply voltage. Such rectifiers may be of the ‘6-pulse type’, wherein two diodes are provided for each phase of a three-phase supply, for instance. However, owing to their relatively slow switching frequencies, such diode rectifiers can produce harmonic electrical signals where voltage harmonics are undesirably transferred back into the grid AC power supply while current harmonics are drawn from the grid AC power supply. This can be alleviated using filters or ‘chokes’ in the motor drive circuits, prior to rectification, that absorb the harmonic signals. However, such filters typically have a large footprint and furthermore utilise valuable power in the additional circuitry required. The ‘choking’ of a vacuum pump supply is particularly relevant where stringent energy supply requirements of energy suppliers must be met. Owing to the size and cost of provisioning such systems, they are an undesirable consequence of diode rectification in the vacuum equipment market.

In addition, vacuum pump installations are required Worldwide. However, Worldwide grid supply voltages vary substantially, often requiring tailored installations. Typically, Worldwide grid power supplies can be grouped into two categories. These are 400V supplies (which, as line-to-line RMS voltages, can vary from circa 380-480V AC) and 200V supplies (which, as line-to-line RMS voltages, can vary from circa 200-230V AC). Vacuum pump manufacturers have conventionally catered for these two categories by providing 400V class vacuum pumps and 200V class vacuum pumps. Furthermore, the full load current of vacuum pumps is significantly high, again adding to the high cost of installation and operation.

The discussion above is merely provided for general background information and is not intended to be used as an aid in determining the scope of the claimed subject matter. The claimed subject matter is not limited to implementations that solve any or all disadvantages noted in the background.

### SUMMARY

In an aspect, there is provided a circuit for driving a motor of a vacuum pump. The circuit comprises a first filter configured to receive an alternating current (AC) electrical input power from an AC power supply, wherein the first filter is configured to supply, based on the AC electrical input power, a filtered AC electrical power. The circuit further comprises a first active-front-end (AFE) rectifier configured to receive the filtered AC electrical power, wherein the first AFE rectifier comprises a plurality of electrically connected first switching devices, wherein the plurality of electrically connected first switching devices are controllable, by a plurality of first switching signals, to convert the filtered AC electrical power to a first direct current (DC) electrical power. The circuit further comprises a first inverter configured to receive the first DC electrical power, wherein the first inverter is further configured to convert the first DC electrical power to an AC electrical output power for driving a first motor of a first vacuum pump.

Some embodiments further comprise a first controller connected to the first AFE rectifier, the first controller being configured to provide the plurality of first switching signals.

In some embodiments, the first AFE rectifier further comprises one or more first sensors for monitoring the first filtered AC electrical power and/or the first DC electrical power, wherein the first controller is configured to adaptively generate the plurality of first switching signals based on one or more sensed signals received from the one or more first sensors.

In some embodiments, the first AFE rectifier is configured to generate the first DC electrical power to comprise a DC boost voltage, wherein the DC boost voltage is greater than an AC voltage of the first filtered AC electrical power.

In some embodiments, the DC boost voltage is adjustable by the first controller.

In some embodiments a ‘boost ratio’ of the DC boost voltage to the line-to-line peak AC voltage is at least 2:1, more preferably at least 3:1. Such a ratio may be required for a wide input voltage range. However, some embodiments may alternatively utilise a ratio of approximately 1.05:1, where the AC voltage is expressed as a line-to-line peak AC voltage (or expressed differently, approximately 1.5:1, for instance, as a minimum boost based on the ratio of DC to line-to-line RMS AC voltage). A minimum boost can minimise losses in the AFE. A larger boost allows operation from a lower supply voltage.

In some embodiments, the DC boost voltage is selected from the range of 500-800V DC. Such a DC boost voltage is particularly relevant for a 400V class vacuum pump system. More specifically, DC boost voltages of 535V DC or 782V DC may be used. Alternatively, for a 200V class vacuum pump system, a preferred DC boost voltage is 375V DC.

In some embodiments, the plurality of electrically connected first switching devices comprises a plurality of Silicon Carbide (SIC) and/or Gallium Nitride (GaN) metal-oxide-semiconductor field-effect transistors (MOSFETs).

In some embodiments, the first filter, first AFE rectifier and first inverter, are arranged on a single, common, circuit board, and/or in a single, common, electrical module.

Some embodiments further comprise at least a second additional AFE rectifier electrically connected in parallel with the first AFE rectifier.

In a further aspect, there is provided a vacuum pump assembly comprising: a first vacuum pump comprising a first motor; and a circuit according to any one of claims 1-10, for driving the first motor.

In some embodiments of the vacuum pump assembly, the circuit is integrated within a casing of the first vacuum pump.

In some embodiments of the vacuum pump assembly, the vacuum pump assembly further comprises a second vacuum pump comprising a second motor, wherein the circuit comprises a second inverter, the second inverter being configured to receive the first DC electrical power, wherein the second inverter is further configured to convert the first DC electrical power to a second AC electrical output power for driving the second motor of the second vacuum pump. Wherein the first inverter and the second inverter are connected via a common DC electrical bus, such that electrical power can flow from the first inverter to the second inverter.

In some embodiments of the vacuum pump assembly, the first motor is configured to operate in a generator or braking mode, wherein, when operating in the generator or braking mode: the first motor is configured to generate electrical power; and the second inverter is configured to use the generated electrical power, via the common DC electrical bus, for supplying power to the second motor. Alternatively, the second motor is configured to operate in a generator or braking mode, wherein, when operating in the generator or braking mode: the second motor is configured to generate electrical power; and the first inverter is configured to use the generated electrical power, via the common DC electrical bus, for supplying power to the first motor.

According to a further aspect, there is provided a method of driving a motor of a vacuum pump, the method comprising receiving, by a first filter, an AC electrical input power from an AC power supply. The method further comprising supplying, by the first filter, a filtered AC electrical power based on the AC electrical input power. The method further comprising receiving, by a first AFE rectifier, the filtered AC electrical power, wherein the first AFE rectifier comprises a plurality of electrically connected first switching devices, the plurality of electrically connected first switching devices being controllable, by a plurality of first switching signals, to convert the filtered AC electrical power to a first DC electrical power. The method further comprising controlling, the plurality of electrically connected first switching devices, using the plurality of first switching signals, thereby generating the first DC electrical power. The method further comprising receiving, by a first inverter, the first DC electrical power. The method further comprising converting, by the first inverter, the first DC electrical power to an AC electrical output power. The method further comprising driving, using the AC electrical output power, a first motor of a first vacuum pump.

By providing one or more AFE rectifier circuits into a vacuum pump, supplied by three phase power, the function of prior art three phase diode rectifiers is replaced. Several benefits are realised which comprise almost total elimination of current harmonics drawn from an input AC power supply (allowing certain electrical supply standards to be met); reduction of the rms current drawn from the supply by approximately 30% (reducing installation and running costs); the option to operate over a wide input voltage range (by over rating the AFE, bringing the benefit of reducing product variants required for different voltages Worldwide); the option to return power to the in AC power supply through bi-directional power transfer (allowing fast and efficient deceleration of a vacuum pump-which can support energy saving, reliability improvement, noise reduction and other application benefits).

In some embodiments, the first AFE rectifier is configured to allow bidirectional power flow, such that power from decelerating the first vacuum pump can be fed back into the mains supply to allow fast and efficient deceleration of the first vacuum pump. This may be useful for pressure control. This is true in embodiments comprising only a single vacuum pump and in the embodiments where there are two or more vacuum pumps connected via a common DC bus, because the ability to send power back to the mains removes the limit on braking power, so the braking power can now exceed the motor consumption of the other vacuum pump.

The summary is provided to introduce a selection of concepts in a simplified form that are further described in the detailed description. This summary is not intended to identify key features or essential features of the claimed subject matter, nor is it intended to be used as an aid in determining the scope of the claimed subject matter.

### BRIEF DESCRIPTION OF THE DRAWINGS

The present invention will now be described, by way of example only, with reference to the accompanying drawings, in which:

FIG. 1 illustrates a prior art vacuum pump assembly;

FIG. 2 illustrates an embodiment of a vacuum pump assembly comprising a circuit for driving a motor of a vacuum pump;

FIG. 3 illustrates a further embodiment of a vacuum pump assembly comprising a circuit for driving a motor of a vacuum pump; and

FIG. 4 illustrates an embodiment of a method of driving a motor of a vacuum pump.

### DETAILED DESCRIPTION

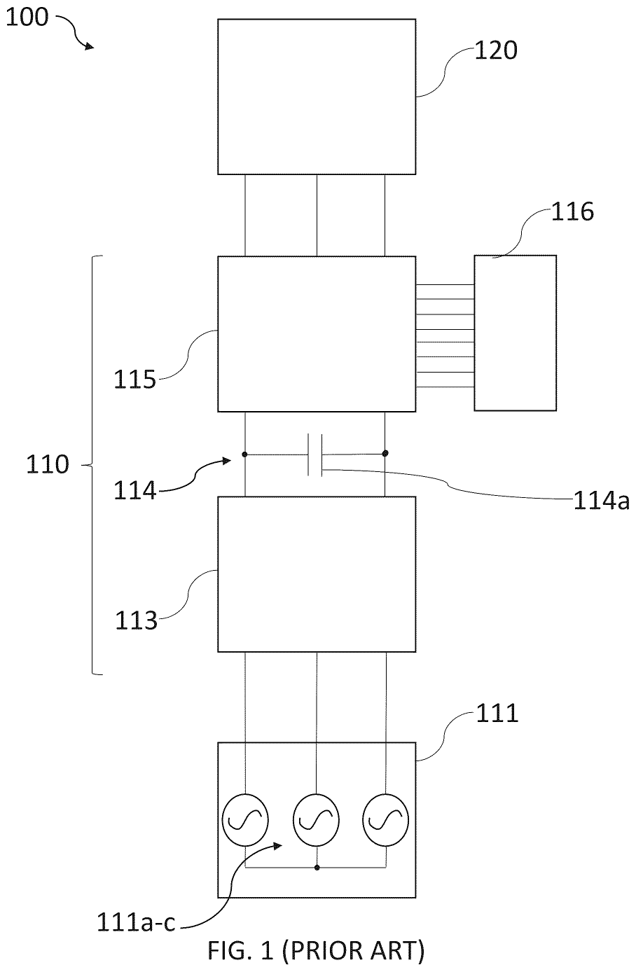

FIG. 1 illustrates a prior art vacuum pump assembly 100 comprising a circuit 110 for driving a motor of a vacuum pump 120.

The circuit 110 receives an alternating current (AC) electrical input power from a three-phase AC power supply 111. The power supply 111 is illustrated as comprising three separate phases 111a-c.

The circuit 110 itself comprises a diode bridge rectifier 113. The diode bridge rectifier 113 is electrically connected to each phase 111a-c of the power supply 111. The diode bridge rectifier 113 converts the received AC electrical power to a direct current (DC) electrical power, which is output by the rectifier 113. The diode bridge rectifier 113 is of the six-pulse type, comprising two diodes for each phase 111a-c of the received AC electrical power, although larger prior art rectifiers comprising twelve or eighteen diodes exist.

The circuit 110 further comprises a DC electrical link 114 electrically connecting the output of the diode bridge rectifier 113 to an input of an electrical inverter 115. The DC link 114 is buffered by a capacitor 114a.

The electrical inverter 115 is configured to receive the first DC electrical power via the DC link 114, and to convert the DC electrical power to an AC electrical output power for driving a motor of a vacuum pump 120. The electrical inverter 115 is electrically connected to the vacuum pump 120 for each phase of the AC electrical output power, in this instance, illustrated as comprising three electrical connections. The motor of vacuum pump 120 is an induction or permanent magnet (PM) motor as is commonly used.

An inverter controller 116 is also electrically connected to the electrical inverter 115. The inverter controller 116 monitors the motor of vacuum pump 120 and generates related control signals for the inverter 115.

The diode rectifier 113 in the vacuum pump assembly 100 may be fitted with relatively large and expensive electrical shunts or chokes to reduce the harmonics generated by the circuit 110 and to reduce the higher than needed full load current of the vacuum pump assembly 100. Such additional circuitry has inherent electrical losses, resulting in increased power drawn from the AC input power supply (typically 1%-5% additional power is drawn).

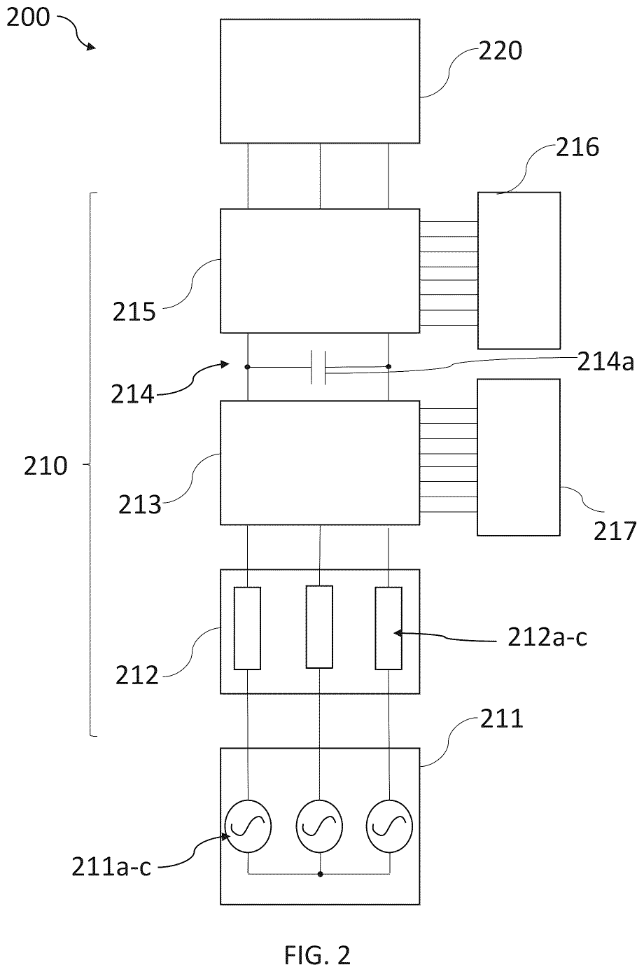

FIG. 2 illustrates an embodiment of a vacuum pump assembly 200 comprising a circuit 210 for driving a motor of a vacuum pump 220.

The circuit 210 receives an AC electrical input power from a three-phase AC power supply 211. The power supply 211 is illustrated as having three separate phases 211a-c.

The first filter 212 is configured to supply/output, based on the AC electrical input power, a filtered AC electrical power. The first filter 212 comprises three harmonic filters 212a-c, one for each phase of the AC electrical input power.

The circuit 210 further comprises a first active-front-end (AFE) rectifier 213 configured to receive the filtered AC electrical power. The first AFE rectifier 213 comprises a plurality of electrically connected first switching devices, wherein the plurality of electrically connected first switching devices are controllable, by a plurality of first switching signals, to convert the filtered AC electrical power to a first direct current (DC) electrical power. The first AFE rectifier 213 is electrically connected to each filter 212a-c of the first filter 212. The first AFE rectifier 213 therefore receives as an input from the first filter 212, the filtered AC electrical power. The first AFE rectifier 213 converts the filtered AC electrical power to the first DC electrical power, and outputs first DC electrical power.

The circuit 210 further comprises a DC electrical link 214 electrically connecting the output of the first AFE rectifier 213 to an input of an electrical first inverter 215. The DC link 214 is buffered by a capacitor 214a.

The first inverter 215 is configured to receive the first DC electrical power via the DC link 214, and to convert the first DC electrical power to an AC electrical output power for driving a motor of a vacuum pump 220. The electrical inverter 215 is electrically connected to the vacuum pump 220 for each phase of the AC electrical output power, in this instance, illustrated as comprising three electrical connections. The motor of vacuum pump 220 is an induction or permanent magnet (PM) motor as is commonly used.

Also shown is a first inverter controller 216, electrically connected to the electrical inverter 215. The first inverter controller 216 monitors the motor of vacuum pump 220 and generates related control signals for the first inverter 215.

Also shown is a first controller 217 for the first AFE rectifier 213. The first controller 217 is electrically connected to first AFE rectifier 213. The first controller 217 is configured to provide the plurality of first switching signals to the first AFE rectifier 213 for controlling the plurality of first switching devices. The first AFE controller 217 may comprise software for software control.

The plurality of electrically connected first switching devices of the first AFE rectifier 213, comprise Silicon Carbide (SiC) and/or Gallium Nitride (GaN) metal-oxide-semiconductor field-effect transistors (MOSFETs).

The first AFE rectifier 213 is configured to generate the first DC electrical power to comprise a variable/adjustable DC boost voltage, wherein the DC boost voltage is greater than an AC voltage of the first filtered AC electrical power. The controller 217 is further configured to adjust the DC boost voltage.

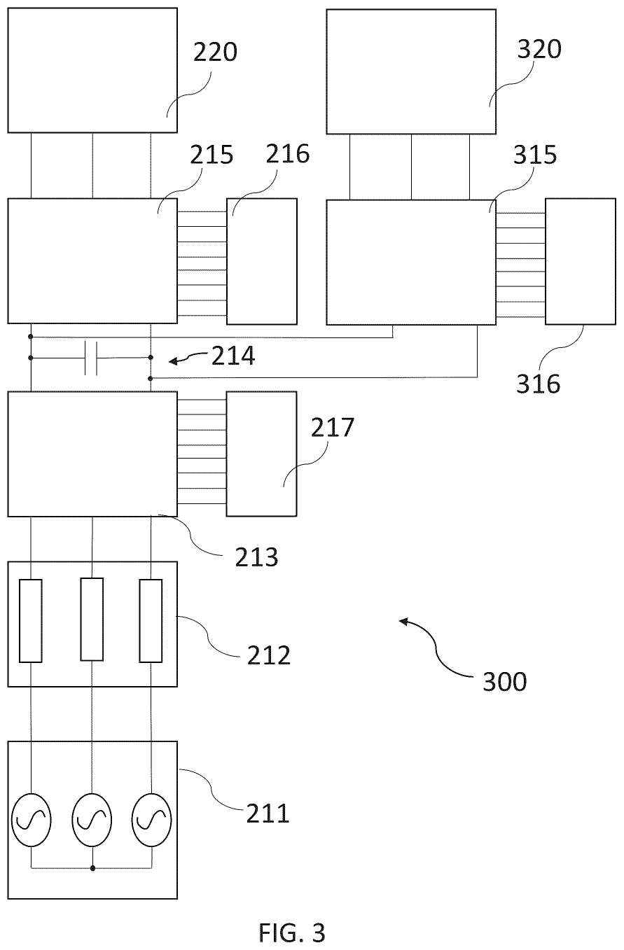

Advantageously, the passive filter 212, first AFE rectifier 213 and controller 217 of FIG. 2, replace the uncontrolled diode bridge rectifier 113 of FIG. 1. This allows for low harmonic current draw from an AC electrical supply and a near unity power factor. The reduction in current harmonics can be sufficient to meet specific customer or power supply company compliance specifications (such as those with stringent harmonic limits, as defined in IEEE standard IEEE519-2014). This is further achieved, in part, through the controller 217 being dedicated to the first AFE rectifier 213, monitoring the first filtered AC electrical power and/or the first DC electrical power, and adaptively generating the plurality of first switching signals based on the monitoring (for instance based on one or more sensed signals received from the one or more first sensors). Hence, the controller 217 is effectively able to control the AC electrical input power and the first DC electrical power on DC link 214. Such a controller is clearly absent from FIG. 1, owing to the uncontrolled nature of the diode bridge rectifier 113 of the prior art. Furthermore, the first AFE rectifier 213 enables bi-directional power transfer as will be described herein, with reference to FIG. 3.

As indicated, the vacuum pump assembly and associated circuit for driving a vacuum pump allows for a reduction in full load current drawn from a supply. This means a vacuum pump can be rendered less expensive to install. It may be necessary to deploy a vacuum pump assembly as a replacement i.e. as a retrofit. Advantageously the vacuum pump assemblies described herein can be retrofitted relatively flexibly, owing to the ability to operate at similar or improved performance levels but without an increase in full load current, in comparison to prior art systems.

Advantageously, the switching speeds/frequencies and lower losses of the SiC and/or GaN MOSFETs are unmatched by prior art insulated-gate bipolar-transistor (IGBT) technology, which have historically been the established power switch of choice. As a result of the faster switching speeds, the first filter 212 can be made smaller than for the prior art embodiment illustrated in FIG. 1, allowing, for instance, for integration of the drive circuit 210 into a casing of vacuum pump 220, and avoiding the requirement for expensive peripheral shunt filters supplied in separate additional cabinets for addition to already large integrated vacuum pump systems. Furthermore, the SIC and/or GaN MOSFETs can enable operation of the first AFE rectifier 213 with lower power draw (in comparison with FIG. 1) through the use of synchronous switching. Furthermore, the control of input currents so they are nearly sinusoidal, with correspondingly lower RMS values, also assists in reducing loss in the input chokes of the drive circuit.

Advantageously, because the first AFE rectifier 213 is operated in a mode where the first DC electrical power comprises a variable/adjustable DC boost voltage that is boosted above the level generated by a traditional diode rectifier, and because the level of boost can be controlled by the controller 217, the first AFE rectifier 213 can be used to convert the voltage level between that provided by the mains supply (input AC electrical power) and that required by the motor of the vacuum pump 220. This allows operation over a wide input voltage range. This function of converting voltage level is already provided by the first inverter 215 that feeds the motor of vacuum pump 220 in the sense that the first inverter 215 can step down the voltage from the supply to provide a reduced voltage to the motor of the vacuum pump 220. However, the first AFE rectifier 213 adds the ability to step up the voltage from the supply. Benefits of such functionality for vacuum pumps include conversion of worldwide supply voltages (by boosting the DC voltage provided by 200V supplies, for instance, to a level that would normally only be achieved from 400V supplies) to supply a single motor designed for operation from 400V supplies. This enables the elimination of different voltage variants of products currently required for 200V and 400V supplied territories. Another benefit is using the first AFE rectifier 213 to boost the voltage of DC link 214 to a fixed level to enable an increase in motor voltage, allowing a reduction in motor current and hence a reduction in inverter output rating and cost.

A further advantage is that the DC boost voltage can be utilised to reduce the DC bus capacitance of capacitor 214a. This is because the energy to be stored by capacitor 214a is proportional to capacitance and voltage squared, so small increases in the DC boost voltage can lead to relatively large decreases in capacitance. This is particularly relevant to embodiments wherein the circuit 210 is integrated into a casing of vacuum pump 220.

A further advantage is that the DC boost voltage can be used in conjunction with a motor of vacuum pump 220 that is designed for the boosted voltage. This allows the motor current to be reduced and hence the rating of the inverter 215 can be reduced. For instance at least a 2:1 or 3:1 boost ratio of the DC boost voltage to a voltage of the filtered AC electrical input power, may be deployed. The precise boost voltage may be dependent upon deployment configuration and/or location, however a particular DC boost voltage may be approximately 500V DC. This is because such a DC boost voltage would allow operation with motors configured to run off rectified 400V AC input supplies. Hence a motor already configured for a 400V AC supply could be run off a 200V AC input supply by virtue of the boost applied by the first AFE rectifier.

A further advantage of the DC boost voltage allowing operation of 400V class products from 200V class supplies, is that this reduces product variants and eliminates cases of damage that occur when conventional 200V products are accidently connected to 400V class supplies.

A further advantage of the circuit 210 is that power can returned to an electrical supply to facilitate rapid and efficient deceleration of vacuum pumps (for instance with applications where chambers are vented). Hence regenerated energy can be usefully deployed.

FIG. 3 illustrates a further embodiment 300 of a vacuum pump assembly comprising a circuit for driving a motor of a vacuum pump. The embodiment 300 includes the first filter 212, first AFE rectifier 213 and associated controller 217, DC link 214, first inverter 215 and associated controller 216, first vacuum pump 220, of FIG. 2. Furthermore, the embodiment 300 illustrates the same AC power supply 211 of FIG. 2. However, the embodiment 300 augments that of FIG. 2 by including a second vacuum pump 320 comprising a second motor. Further, the embodiment 300 comprises a second inverter 315 configured to receive the first DC electrical power via DC link 214. The second inverter 315 is further configured to convert the first DC electrical power to a second AC electrical output power for driving the second motor of the second vacuum pump 320. As illustrated, the first inverter 215 and the second inverter 315 are connected via common DC electrical bus/DC link 214, such that electrical power can flow from the first inverter 215 to the second inverter 315. Further illustrated is a second inverter controller 316 for the second inverter 315.

The first AFE rectifier 213 supplies the two (or more) inverters 215, 315, and associated pumps 220 and 320.

The motor of the first vacuum pump 220 is configured to operate in a generator or braking mode, wherein, when operating in the generator or braking mode the motor of the first vacuum pump 220 is configured to generate electrical power, and, the second inverter 315 is configured to use the generated electrical power, via the common DC electrical bus 214, for supplying power to the motor of the second vacuum pump 320.

Advantageously this embodiment yields at least two additional benefits. A first benefit is a reduced number of AFE circuits are required. A second benefit is that bi-directional power transfer between the two inverters 215, 315, can be achieved using the common DC bus/DC link 214, allowing the most efficient reuse of braking energy from one pump 220 by the other pump 320 (allowing braking energy from a main pump to be used by a secondary pump, for instance).

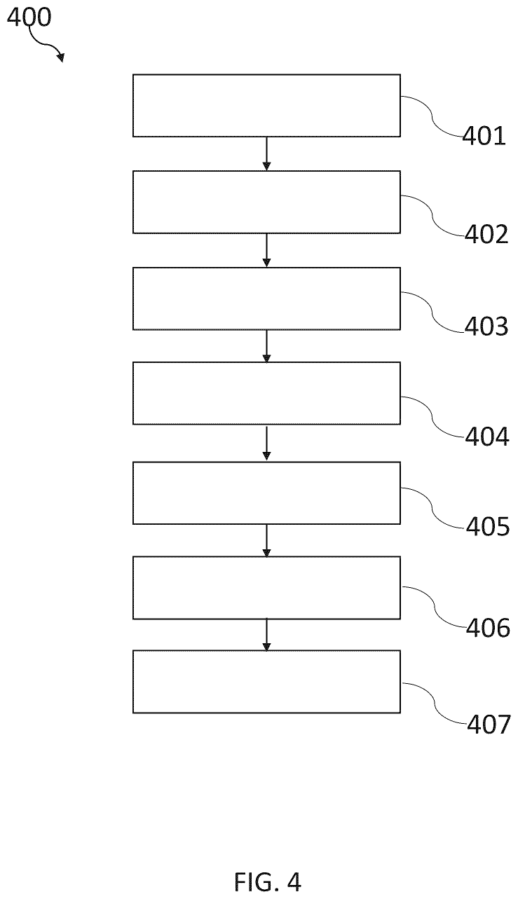

FIG. 4 illustrates an embodiment 400 of a method of driving a motor of a vacuum pump. The method 400 illustrates further how the embodiments 200 and 300 of FIGS. 2 and 3 may be used.

A first step comprises receiving 401, by a first filter, an AC electrical input power from an AC power supply.

A further step comprises supplying 402, by the first filter, a filtered AC electrical power based on the AC electrical input power.

A further step comprises receiving 403, by a first AFE rectifier, the filtered AC electrical power, wherein the first AFE rectifier comprises a plurality of electrically connected first switching devices, the plurality of electrically connected first switching devices being controllable, by a plurality of first switching signals, to convert the filtered AC electrical power to a first DC electrical power.

A further step comprises controlling 404, the plurality of electrically connected first switching devices, using the plurality of first switching signals, thereby generating the first DC electrical power.

A further step comprises receiving 405, by a first inverter, the first DC electrical power.

A further step comprises converting 406, by the first inverter, the first DC electrical power to an AC electrical output power.

A further step comprises driving 407, using the AC electrical output power, a first motor of a first vacuum pump.

Advantageously, the circuits of the vacuum pump assemblies and associated methods described herein reduce the size, weight and cost of pump and abatement systems for numerous applications (for instance Extreme Ultra-Violet applications) by replacing the passive and/or active filters required at the point of common coupling with AFE circuits in the individual pumps. Energy savings in the region of 1%-5% are to be expected. In addition, the circuits and methods provide the ability to power convert to enable the production of universal voltage pumps and further provide the ability to decelerate boost pumps using regenerative braking.

Whilst the embodiments described illustrate circuits comprising a single AFE rectifier, two or more such AFE rectifiers may instead be used. A plurality of AFE rectifiers may be connected in parallel to feed power to one or more inverter circuits to yield additional benefits of reusing existing AFE circuit modules to deliver power beyond the rating of an individual AFE circuit module, and, the provision of redundancy allowing continued operation of a vacuum pump system in the event of failure of one of the AFE rectifiers.

Furthermore, the AFE rectifier in the embodiments described, may be a two-level or even a three-level converter, using unidirectional or bidirectional rectifiers. A preferred implementation may be a 2-level 6-switch bridge that is naturally able to support bidirectional power flow.

Furthermore, the first filter in the embodiments described, may comprise a single inductor or inductor, capacitor and inductor (LCL), or inductor and capacitor (CL) filter. Various variations exist including or excluding Electro-Magnetic Compatibility (EMC) filters for attenuating Electro-Magnetic Interference (EMI) in order to meet certain standards relating to EMC.

The embodiments described herein illustrate single AFE rectifiers feeding one or more inverters, and with one AFE rectifier feeding each inverter, and with several AFE rectifiers operating in parallel to feed one or more inverters. These AFE circuits could be fully integrated into a single inverter module, or may be provided as separate modules.

As described herein, 400V supplies includes supplies that vary from circa 380-480V, and 200V supplies include supplies which can vary from circa 200-230V.

Whilst the first controller connected to the first AFE rectifier and the first inverter controller, are illustrated as separate controllers in the embodiments shown, they may, in other embodiments, form part of a common controller/controller unit.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are described as example forms of implementing the claims.

1. A circuit for driving a motor of a vacuum pump, wherein the circuit comprises:
a first filter configured to receive an alternating current ‘AC’ electrical input power from an AC power supply, wherein the first filter is configured to supply, based on the AC electrical input power, a filtered AC electrical power;
a first active-front-end ‘AFE’ rectifier configured to receive the filtered AC electrical power, wherein the first AFE rectifier comprises a plurality of electrically connected first switching devices, wherein the plurality of electrically connected first switching devices are controllable, by a plurality of first switching signals, to convert the filtered AC electrical power to a first direct current ‘DC’ electrical power; and
a first inverter configured to receive the first DC electrical power, wherein the first inverter is further configured to convert the first DC electrical power to an AC electrical output power for driving a first motor of a first vacuum pump.

2. The circuit of claim 1, further comprising:
a first controller connected to the first AFE rectifier, the first controller being configured to provide the plurality of first switching signals.

3. The circuit of claim 2, wherein the first AFE rectifier further comprises one or more first sensors for monitoring the first filtered AC electrical power and/or the first DC electrical power, wherein the first controller is configured to adaptively generate the plurality of first switching signals based on one or more sensed signals received from the one or more first sensors.

4. The circuit of claim 2, wherein the first AFE rectifier is configured to generate the first DC electrical power to comprise a DC boost voltage, wherein the DC boost voltage is greater than an AC voltage of the first filtered AC electrical power.

5. The circuit of claim 4, wherein the DC boost voltage is adjustable by the first controller.

6. The circuit of claim 4, wherein a boost ratio of the DC boost voltage to the line-to-line peak value of the AC voltage is at least 2:1, more preferably at least 3:1.

7. The circuit of claim 4, wherein the DC boost voltage is 500-800V DC.

8. The circuit of claim 1, wherein the plurality of electrically connected first switching devices comprises a plurality of Silicon Carbide ‘SiC’ and/or Gallium Nitride ‘GaN’ metal-oxide-semiconductor field-effect transistors ‘MOSFETs’.

9. The circuit of claim 1, wherein the first filter, first AFE rectifier and first inverter, are arranged:
on a single, common, circuit board; and/or
in a single, common, electrical module.

10. The circuit of claim 1, further comprising at least a second additional AFE rectifier electrically connected in parallel with the first AFE rectifier.

11. A vacuum pump assembly comprising:
a first vacuum pump comprising a first motor;
and a circuit according to claim 1, for driving the first motor.

12. The vacuum pump assembly of claim 11, wherein the circuit is integrated within a casing of the first vacuum pump.

13. The vacuum pump assembly of claim 11, further comprising:
a second vacuum pump comprising a second motor;
wherein the circuit comprises a second inverter, the second inverter being configured to receive the first DC electrical power, wherein the second inverter is further configured to convert the first DC electrical power to a second AC electrical output power for driving the second motor of the second vacuum pump;
wherein the first inverter and the second inverter are connected via a common DC electrical bus, such that electrical power can flow from the first inverter to the second inverter.

14. The vacuum pump assembly of claim 13, wherein:
the first motor is configured to operate in a generator or braking mode, wherein, when operating in the generator or braking mode:
the first motor is configured to generate electrical power; and
the second inverter is configured to use the generated electrical power, via the common DC electrical bus, for supplying power to the second motor; or
the second motor is configured to operate in a generator or braking mode, wherein, when operating in the generator or braking mode:
the second motor is configured to generate electrical power; and
the first inverter is configured to use the generated electrical power, via the common DC electrical bus, for supplying power to the first motor.

15. A method of driving a motor of a vacuum pump, the method comprising:
receiving, by a first filter, an AC electrical input power from an AC power supply;
supplying, by the first filter, a filtered AC electrical power based on the AC electrical input power;
receiving, by a first AFE rectifier, the filtered AC electrical power, wherein the first AFE rectifier comprises a plurality of electrically connected first switching devices, the plurality of electrically connected first switching devices being controllable, by a plurality of first switching signals, to convert the filtered AC electrical power to a first DC electrical power;
controlling, the plurality of electrically connected first switching devices, using the plurality of first switching signals, thereby generating the first DC electrical power;
receiving, by a first inverter, the first DC electrical power;
converting, by the first inverter, the first DC electrical power to an AC electrical output power; and
driving, using the AC electrical output power, a first motor of a first vacuum pump.
